(19) United States
(12) Patent Application Publication
(10) Pub. No.: US 2020/0033218 A1
(43) Pub. Date: Jan. 30, 2020

(54) PRESSURE SENSOR

(71) Applicant: MIKUNI CORPORATION, Tokyo (JP)

(72) Inventors: Tomoya SATO, Iwate (JP); Katsuhiko FUKUI, Iwate (JP)

(73) Assignee: MIKUNI CORPORATION, Tokyo (JP)

(21) Appl. No.: 16/520,352

(22) Filed: Jul. 23, 2019

(30) Foreign Application Priority Data
Jul. 25, 2018 (JP) 2018-138951

(51) Int. Cl. G01L 23/10; G01L 23/02; G01L 23/26

(52) U.S. Cl. CPC G01L 23/10; G01L 23/26; G01L 23/02

(57) ABSTRACT

A pressure sensor is provided. In a pressure sensor including tubular housings, a diaphragm fixed to a tip end of the housing and exposed to a pressured medium, and a pressure measurement member constituted by a first electrode, a piezoelectric element, and a second electrode which are sequentially stacked inside the housing, a heat-insulating member disposed inside the housing so as to be interposed between the diaphragm and the first electrode is provided.

### CROSS-REFERENCE TO RELATED APPLICATION

This application claims the priority of Japan patent application serial no. 2018-138951, filed on Jul. 25, 2018. The entirety of the above-mentioned patent application is hereby incorporated by reference herein and made a part of this specification.

### BACKGROUND

### Technical Field

The disclosure relates to a pressure sensor that detects a pressure of a pressured medium, and more particularly, to a pressure sensor that detects a pressure of a high temperature pressured medium such as a combustion gas inside a combustion chamber of an engine.

### Description of Related Art

As a pressure sensor of the related art, there has become known a combustion pressure sensor that includes a tubular housing, a bottomed tubular diaphragm coupled to a tip end of the housing, a first electrode disposed in contact with the diaphragm, a piezoelectric element disposed in contact with the first electrode, a second electrode disposed so as to sandwich the piezoelectric element in cooperation with the first electrode, an insulating ring disposed in contact with the second electrode, a supporting member disposed in contact with the insulating ring, and a tubular case accommodating the piezoelectric element, the second electrode, and the insulating ring and coupled to the first electrode and the outer peripheral surface of the supporting member, and detects a combustion pressure of a combustion gas in a combustion chamber (for example, Japanese Patent Laid-Open No. 2016-121955).

In the pressure sensor, the diaphragm deformed due to a received combustion pressure exerts a load on the piezoelectric element through the first electrode, so that a combustion pressure is detected.

Here, all of the diaphragm, the first electrode, the second electrode, the supporting member, and the case are formed of a metal material. Therefore, the pressure sensor has a structure in which when the diaphragm receives heat due to a combustion gas, the heat is transferred to the piezoelectric element through the first electrode.

On the other hand, the piezoelectric element has negative characteristics (NTC characteristic) in which an electrical resistance value decreases with an increase in the temperature thereof (NTC characteristic). Therefore, there is a concern that an increase in the temperature of the piezoelectric element due to heat transfer may result in decrease in sensor accuracy due to fluctuation in a reference point (zero point) of a sensor output.

### PATENT DOCUMENTS

[Patent Document 1] Japanese Patent Laid-Open Publication No. 2016-121955

### SUMMARY

An aspect of the disclosure provides a pressure sensor including a conductive housing which is configured to have a tubular shape, a conductive diaphragm which is fixed to a tip end of the housing and exposed to a pressured medium, a pressure measurement member which includes a first electrode, a piezoelectric element, and a second electrode which are sequentially stacked inside the housing, a preload imparting member which is disposed inside the housing in order to press the pressure measurement member toward the diaphragm to impart a preload, and a heat-insulating member disposed inside the housing so as to be interposed between the diaphragm and the first electrode.

According to an embodiment of the disclosure, in the pressure sensor, the diaphragm includes a flexible plate-shaped portion fixed to the housing and a protrusion portion protruding toward an inside of the housing from a center region of the flexible plate-shaped portion, and, the heat-insulating member is disposed so as to be interposed between the protrusion portion and the first electrode.

According to an embodiment of the disclosure, in the pressure sensor, the preload imparting member includes a conductive fixation member fixed to the housing and an insulating member disposed between the fixation member and the second electrode.

According to an embodiment of the disclosure, in the pressure sensor, a thermal conductivity of the insulating member is higher than a thermal conductivity of the heat-insulating member.

According to an embodiment of the disclosure, in the pressure sensor, a volume of the heat-insulating member is larger than a volume of the insulating member.

According to an embodiment of the disclosure, the pressure sensor further includes a positioning member formed of an insulating material and disposed inside the housing, and the pressure measurement member is fitted to the positioning member so as to be positioned on an axial line of the housing.

According to an embodiment of the disclosure, in the pressure sensor, the preload imparting member includes a conductive fixation member fixed to the housing and an insulating member disposed between the fixation member and the second electrode, and a thermal conductivity of the positioning member is lower than a thermal conductivity of the insulating member.

According to an embodiment of the disclosure, in the pressure sensor, the diaphragm includes a flexible plate-shaped portion fixed to the housing and a protrusion portion protruding toward an inside of the housing from a center region of the flexible plate-shaped portion, and the positioning member is disposed separated from the flexible plate-shaped portion.

According to an embodiment of the disclosure, in the pressure sensor, the positioning member is configured in a tubular shape so as to surround the heat-insulating member.

According to an embodiment of the disclosure, in the pressure sensor, the positioning member is configured to serve as the heat-insulating member.

According to an embodiment of the disclosure, in the pressure sensor, the heat-insulating member is configured to have conductivity and thermal insulation, and a conductor which is led while being insulated from the housing is connected to the second electrode.

According to an embodiment of the disclosure, in the pressure sensor, the heat-insulating member is formed of an insulating material. A first conductor connected to the diaphragm is connected to the first electrode, and a second conductor which is led while being insulated from the housing is connected to the second electrode.

According to an embodiment of the disclosure, in the pressure sensor, the first conductor is a compression spring which is disposed between the diaphragm and the first electrode in a through hole provided in the heat-insulating member.

According to an embodiment of the disclosure, in the pressure sensor, the preload imparting member includes a conductive fixation member fixed to the housing and an insulating member disposed between the fixation member and the second electrode, the heat-insulating member is formed of an insulating material. A first conductor connected to the fixation member is connected to the first electrode, and a second conductor which is led while being insulated from the housing is connected to the second electrode.

According to an embodiment of the disclosure, in the pressure sensor, the heat-insulating member is formed of an insulating material A first conductor which is led while being insulated from the housing is connected to the first electrode, and a second conductor which is led while being insulated from the housing is connected to the second electrode.

According to an embodiment of the disclosure, the pressure sensor further includes a positioning member formed of an insulating material and disposed inside the housing, and the pressure measurement member is fitted to the position member so as to be positioned on an axial line of the housing. The housing includes an external housing and a sub-housing which is fitted into and fixed to the external housing, and the diaphragm, the positioning member, the heat-insulating member, the pressure measurement member, and the preload imparting member are disposed inside the sub-housing.

### BRIEF DESCRIPTION OF THE DRAWINGS

FIG. 1 is an appearance perspective view illustrating an embodiment of a pressure sensor according to the disclosure.

FIG. 2 is a cross-sectional view along an axial line of the pressure sensor illustrated in

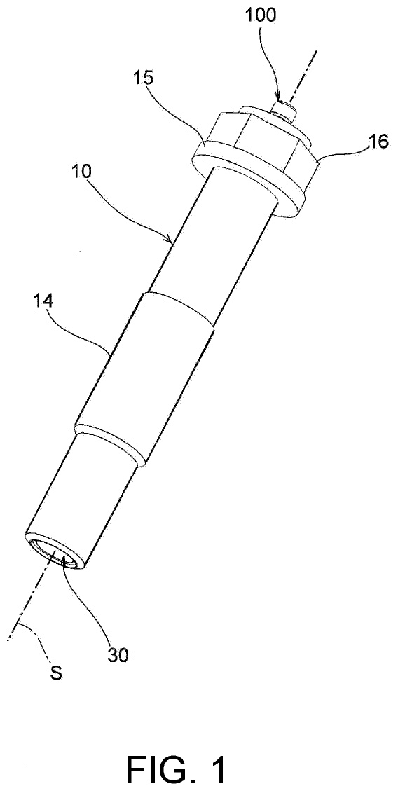

FIG. 1.

FIG. 3 is an exploded perspective view of a sensor module included in the pressure sensor illustrated in FIG. 1.

FIG. 4 is a cross-sectional view of the sensor module illustrated in FIG. 3.

FIG. 5 is a cross-sectional view of the sensor module at a position where the sensor module is rotated by 90 degrees around an axial line S with respect to the cross-section illustrated in FIG. 4.

FIG. 6 is a cross-sectional view illustrating a modification example of the sensor module illustrated in FIG. 4.

FIG. 7 is a cross-sectional view of the sensor module at a position where the sensor module is rotated by 90 degrees around the axial line S with respect to the cross-section illustrated in FIG. 6.

FIG. 8 illustrates another embodiment of a pressure sensor according to the disclosure and is an exploded perspective view of a sensor module included in the pressure sensor.

FIG. 9 is a cross-sectional view of the sensor module illustrated in FIG. 8.

FIG. 10 is a cross-sectional view of the sensor module at a position where the sensor module is rotated by 90 degrees around an axial line S with respect to the cross-section illustrated in FIG. 9.

FIG. 11 is an appearance perspective view illustrating still another embodiment of a pressure sensor according to the disclosure.

FIG. 12 is a cross-sectional view along an axial line of the pressure sensor illustrated in FIG. 11.

FIG. 13 is an exploded perspective view of a sensor module included in the pressure sensor illustrated in FIG. 12.

FIG. 14 is a cross-sectional view of the sensor module illustrated in FIG. 13.

FIG. 15 illustrates still another embodiment of a pressure sensor according to the disclosure and is an exploded perspective view of a sensor module included in the pressure sensor.

FIG. 16 is a cross-sectional view of the sensor module illustrated in FIG. 15.

FIG. 17 illustrates still another embodiment of a pressure sensor according to the disclosure and is an exploded perspective view of a sensor module included in the pressure sensor.

FIG. 18 is a cross-sectional view of the sensor module illustrated in FIG. 17.

FIG. 19 illustrates still another embodiment of a pressure sensor according to the disclosure and is an exploded perspective view of a sensor module included in the pressure sensor.

FIG. 20 is a cross-sectional view of the sensor module illustrated in FIG. 19.

FIG. 21 illustrates still another embodiment of a pressure sensor according to the disclosure and is a cross-sectional view of a sensor module included in the pressure sensor.

### DESCRIPTION OF THE EMBODIMENTS

The disclosure provides a pressure sensor capable of securing predetermined sensor accuracy by suppressing the influence of heat on a piezoelectric element.

According to the pressure sensor having the above-described configuration, it is possible to obtain a pressure sensor capable of securing predetermined sensor accuracy by suppressing the influence of heat on a piezoelectric element.

Hereinafter, embodiments of the disclosure will be described with reference to the accompanying drawings.

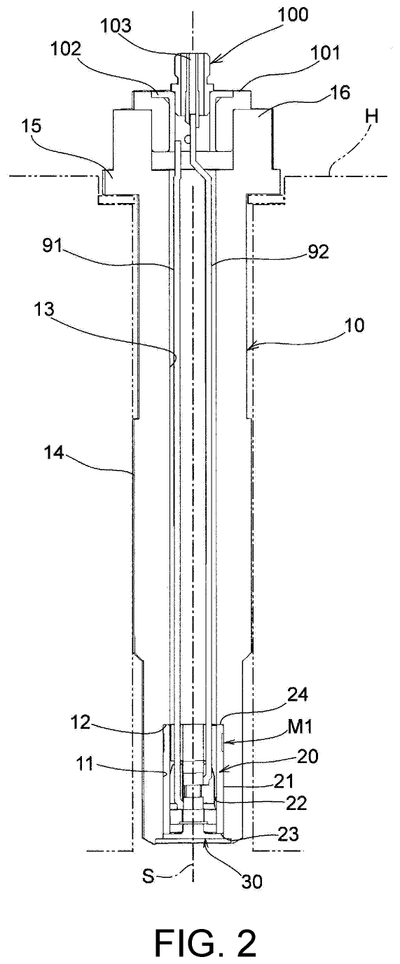

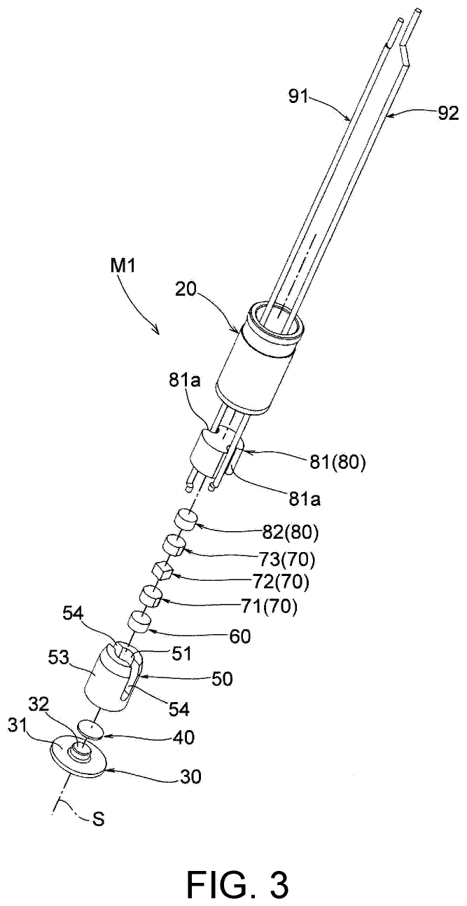

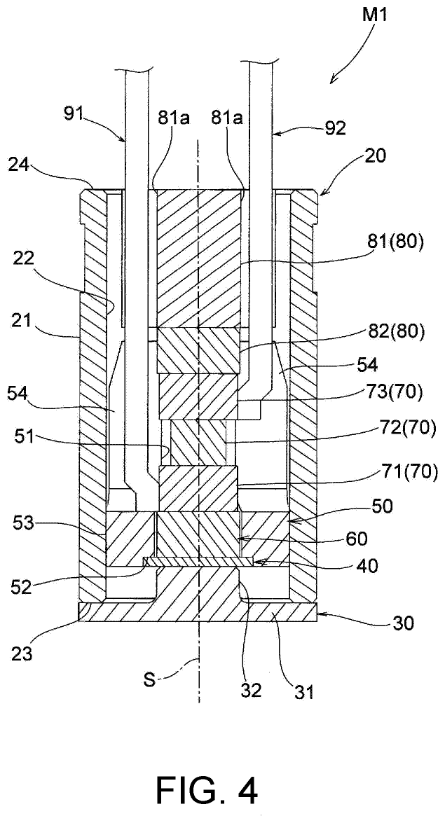

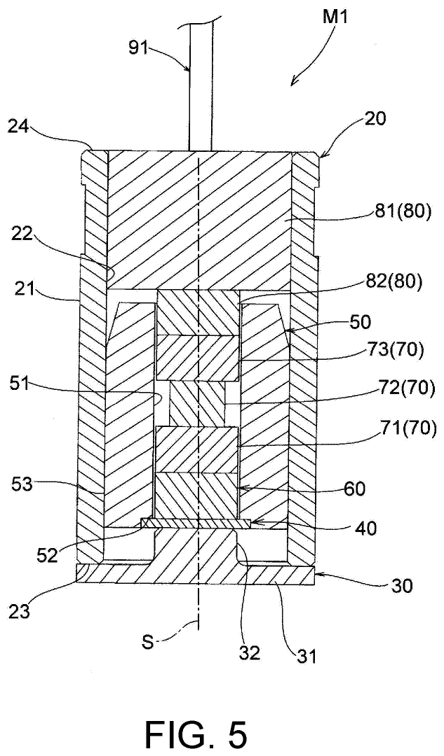

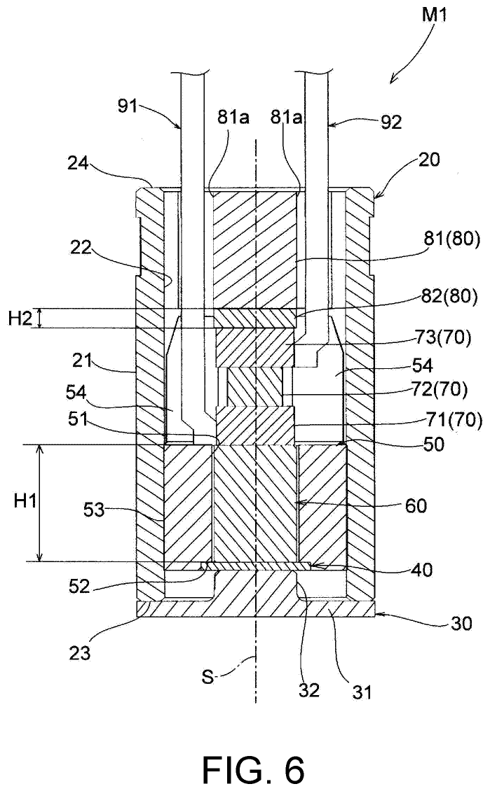

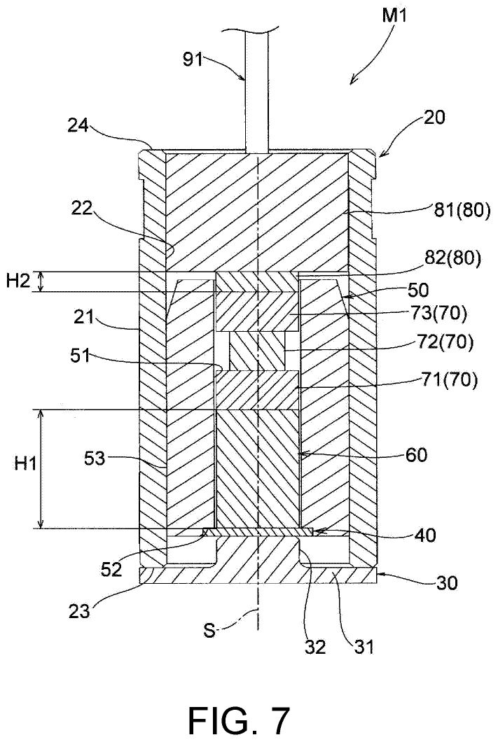

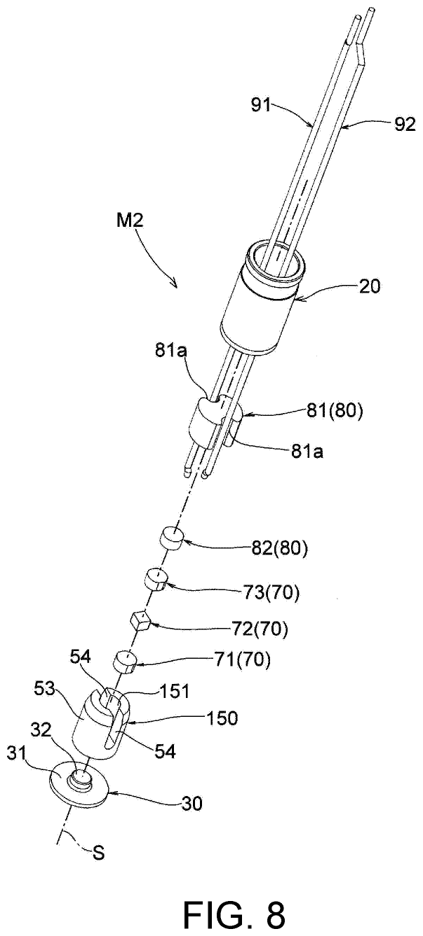

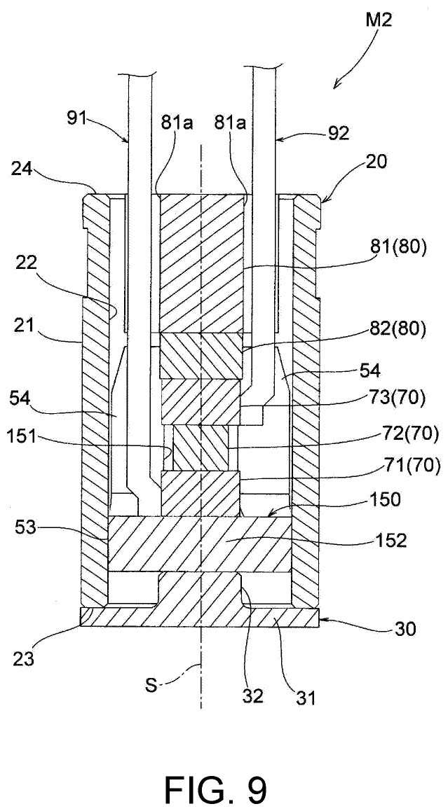

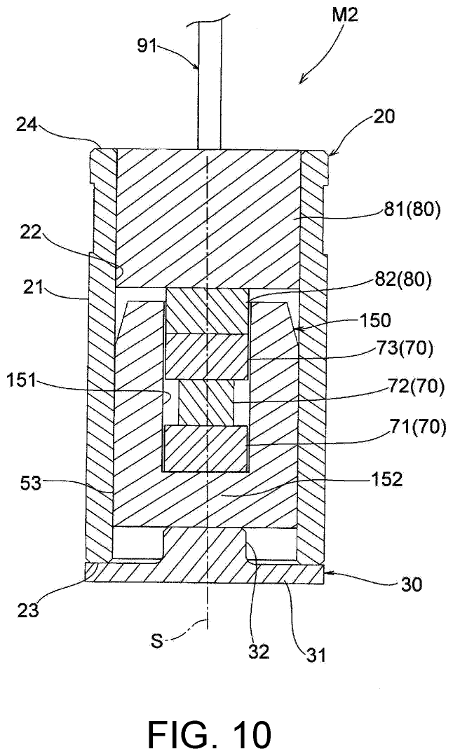

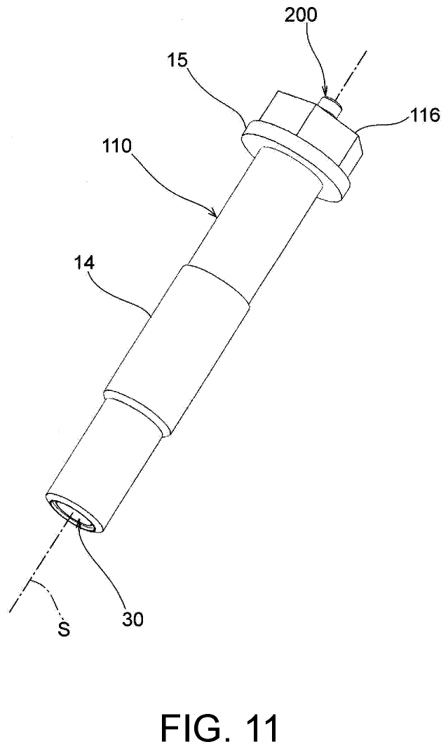

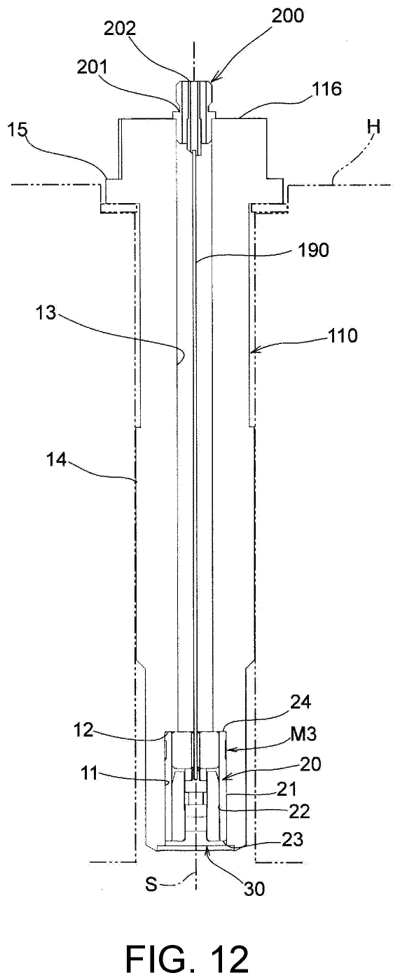

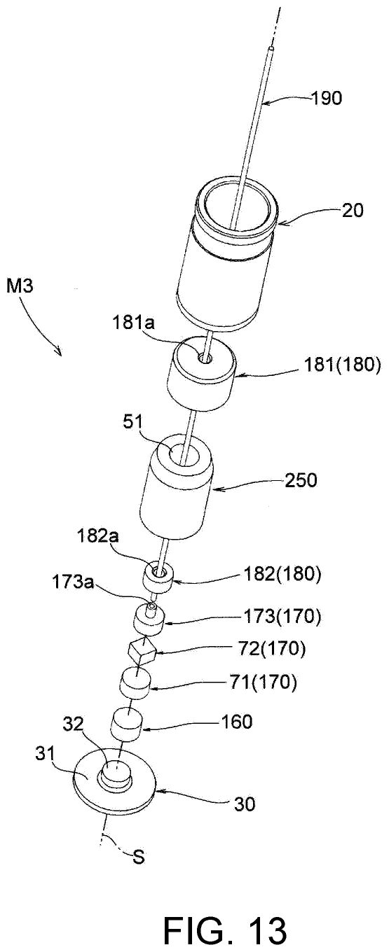

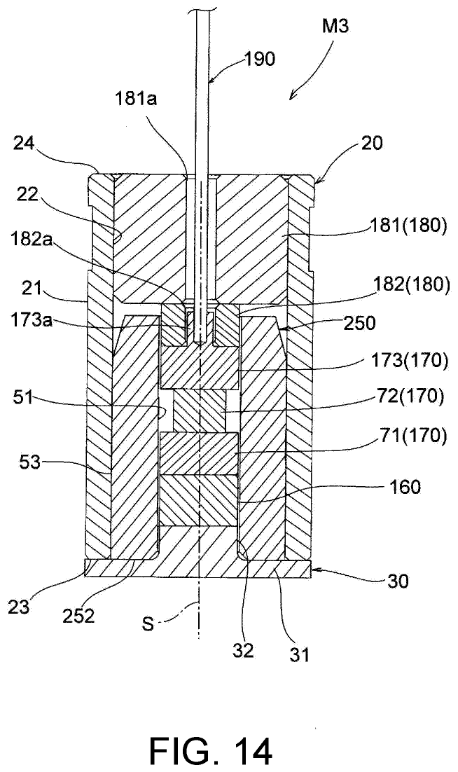

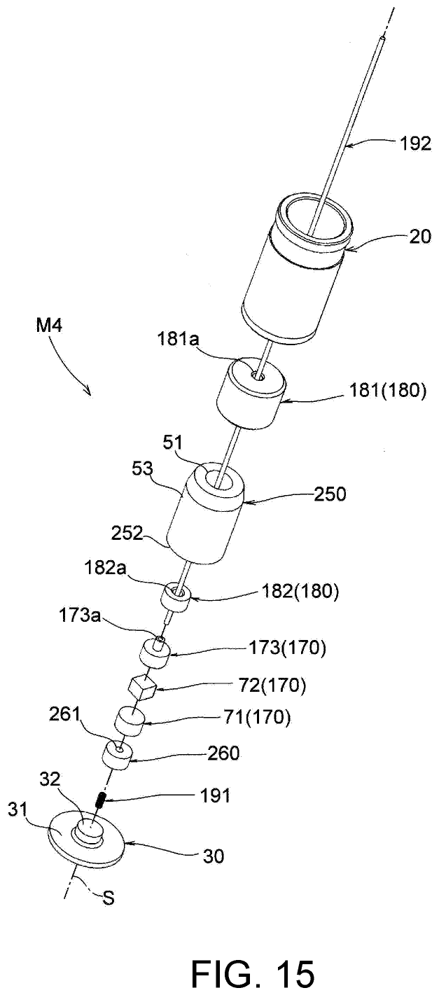

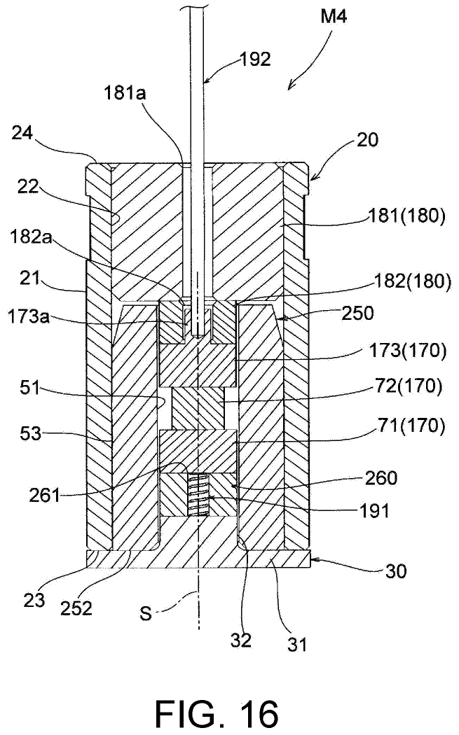

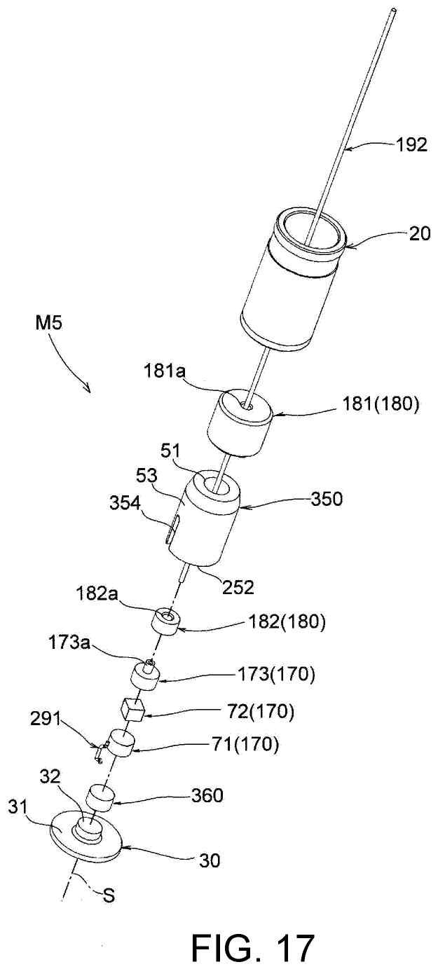

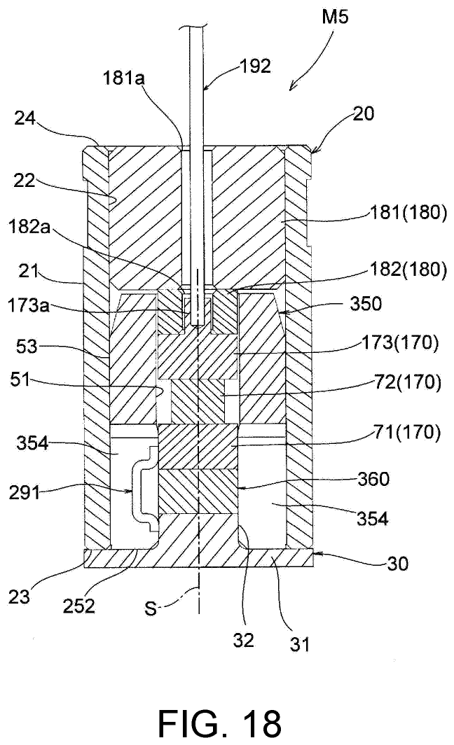

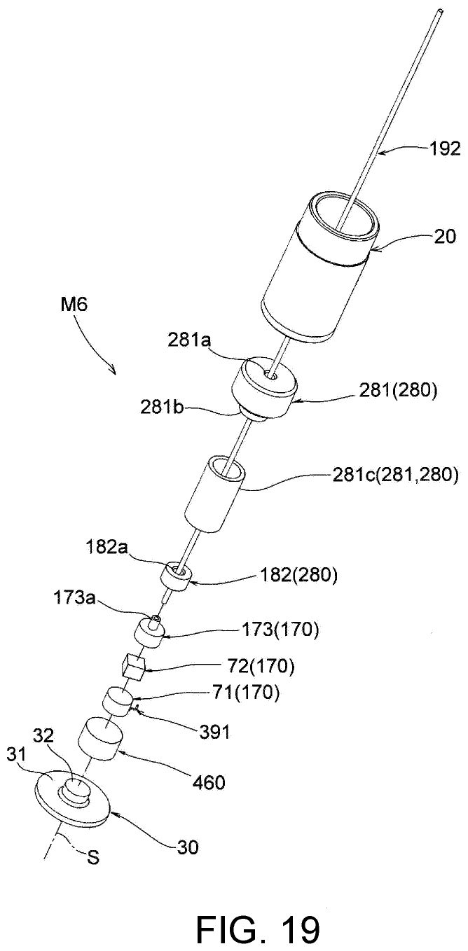

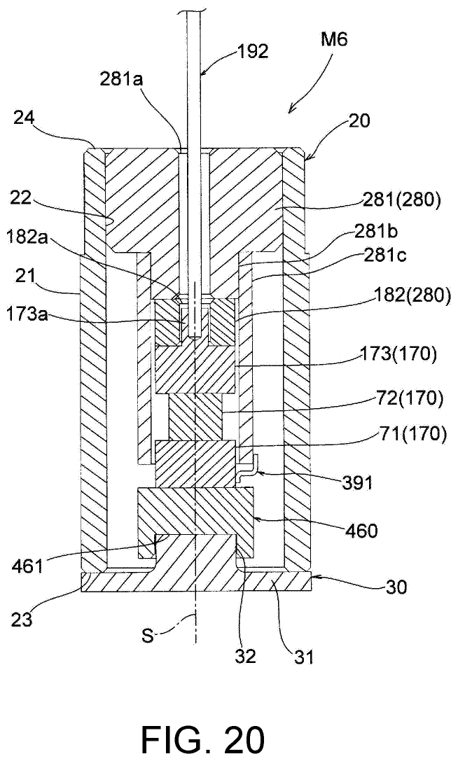

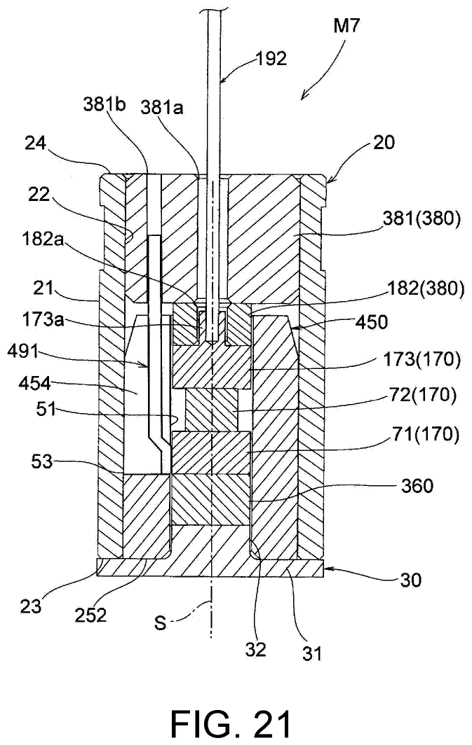

As illustrated in FIG. 2, a pressure sensor according to a first embodiment, which is attached to a cylinder head H of an engine, detects a pressure of a combustion gas inside a combustion chamber as a pressured medium.

As illustrated in FIGS. 1 to 3, the pressure sensor according to the first embodiment includes an external housing 10 and a sub-housing 20 as tubular housings defining an axial line S, a diaphragm 30, a holding plate 40, a positioning member 50, a heat insulating member 60, a pressure measurement member 70, a preload imparting member 80, a lead wire 91 as a first conductor, a lead wire 92 as a second conductor, and a connector 100.

The pressure measurement member 70 is constituted by a first electrode 71, a piezoelectric element 72, and a second electrode 73 which are sequentially stacked in a direction of the axial line S from the tip end side of the housing.

The preload imparting member 80 is constituted by a fixation member 81 and an insulating member 82.

As illustrated in FIGS. 1 and 2, the external housing 10 is formed to have a cylindrical shape extending in the direction of the axial line S by using a metal material such as precipitation hardening or ferritic stainless steel, and includes a fitting inner peripheral wall 11, a stepped portion 12, a through passage 13, a male screw portion 14 formed on the outer peripheral surface thereof, a flange portion 15, and a connector connection portion 16.

As illustrated in FIGS. 4 and 5, the sub-housing 20 is formed to have a cylindrical shape extending in the direction of the axial line S by using a metal material such as precipitation hardening or ferritic stainless steel, and includes an outer peripheral wall 21 fitted to the fitting inner peripheral wall 11, an inner peripheral wall 22 centering around the axial line S, a tip end surface 23, and a back-side end surface 24.

In addition, the sub-housing 20 is fitted into the inside of the external housing 10 so as to be fixed using welding or the like in a state where the diaphragm 30, the holding plate 40, the positioning member 50, the heat insulating member 60, the pressure measurement member 70, the preload imparting member 80, the lead wire 91, and the lead wire 92 are incorporated thereinto.

As illustrated in FIGS. 4 and 5, the diaphragm 30 is formed using a metal material such as precipitation-hardened stainless steel, and includes a flexible plate-shaped portion 31 and a protrusion portion 32 formed to be continuous with the flexible plate-shaped portion 31.

The flexible plate-shaped portion 31 is formed to have an elastically deformable disk shape, and an outer edge region thereof is fixed to the tip end surface 23 of the sub-housing 20 using welding or the like.

A load corresponding to the pressure of a combustion gas acts on the flexible plate-shaped portion 31, and the flexible plate-shaped portion 31 is elastically deformed in the direction of the axial line S due to the load.

That is, the diaphragm 30 is fixed to the tip end of the sub-housing 20 constituting a portion of the housing and is exposed to a high temperature pressured medium.

The protrusion portion 32 is formed to have a columnar shape extending in the direction of the axial line S toward the inside of the sub-housing 20 from a center region of the flexible plate-shaped portion 31 centering on the axial line S.

The outer peripheral surface of the protrusion portion 32 is disposed with an annular gap from the inner peripheral wall 22 of the sub-housing 20.

In addition, the protrusion portion 32 plays a role of transmitting a force received by the flexible plate-shaped portion 31 to the piezoelectric element 72 through the holding plate 40, the heat insulating member 60, and the first electrode 71.

In addition, the protrusion portion 32 is provided, so that a heat transfer amount of heat transferred to the diaphragm 30 is limited by the protrusion portion 32 of which the area is narrowed when the heat is transferred to the inside of the sub-housing 20. Therefore, it is possible to suppress a heat transfer amount moving from the diaphragm 30 to the inside.

As illustrated in FIGS. 4 and 5, the holding plate 40 is formed to have a disk shape having an outer diameter larger than the outer diameter of the protrusion portion 32 by using a metal material such as precipitation hardening or ferritic stainless steel.

In addition, the holding plate 40 is interposed between the protrusion portion 32 of the diaphragm 30 and the heat insulating member 60 to play a role of holding the positioning member 50 so as to be separated from the flexible plate-shaped portion 31 and defining a space between the flexible plate-shaped portion 31 of the diaphragm 30 and the positioning member 50.

Accordingly, it is possible to efficiently suppress heat transfer from the diaphragm 30 to the inside of the housing by the presence of the above-described space.

In addition, the holding plate 40 may be formed of an insulating material or another material as long as it has a high mechanical strength.

As illustrated in FIGS. 4 and 5, the positioning member 50 is formed to have a substantially cylindrical shape extending in the direction of the axial line S by using an insulating material having an electrical insulating property and a thermal insulating property, and includes a through hole 51, a fitting concave portion 52, an outer peripheral surface 53, and two notched grooves 54 for allowing the lead wires 91 and 92 to pass through.

The through hole 51 is formed as a circular hole centering on the axial line S and extending in the direction of the axial line S.

The fitting concave portion 52 is formed as a circular concave portion centering on the axial line S in order to accept the holding plate 40.

The outer peripheral surface 53 is formed as a columnar surface centering on the axial line S in order to be fitted to the inner peripheral wall 22 of the sub-housing 20.

The two notched grooves 54 have the same depth dimension in the direction of the axial line S and are provided at positions point-symmetrical to and separated from each other by 180 degrees around the axial line S.

Here, an insulating material for forming the positioning member 50 may have a high heat capacity and a low thermal conductivity. The thermal conductivity is, for example, preferably equal to or less than 15 W/m·K, and more preferably equal to or less than 5 W/m·K. Examples of a specific material include ceramics such as quartz glass, steatite, zirconia, cordierite, forsterite, mullite, and yttria or a conductive material subjected to insulation treatment.

In addition, the positioning member 50, which is supported by the holding plate 40 abutting against the protrusion portion 32 and fitted to the inner peripheral wall 22 of the sub-housing 20, positions and holds the heat insulating member 60, and the pressure measurement member 70 constituted by the first electrode 71, the piezoelectric element 72, and the second electrode 73, and the insulating member 82 in a stacked state inside the through hole 51.

That is, the positioning member 50 is disposed inside the sub-housing 20 constituting a portion of the housing. The heat insulating member 60, the pressure measurement member 70, and the insulating member 82 are fitted into the through hole 51 so as to be positioned on the axial line S of the housing.

Therefore, it is possible to position the heat insulating member 60, and the first electrode 71, the piezoelectric element 72 and the second electrode 73 that constitute the pressure measurement member 70 on the axial line S with the positioning member 50 as a reference while securing insulating properties of both the electrodes to easily incorporate these components.

Further, a thermal conductivity of the positioning member 50 may be equal to a thermal conductivity of the heat insulating member 60 and lower than a thermal conductivity of the insulating member 82. Thereby, it is also possible to make the positioning member 50 function as a heat insulating member.

Further, the positioning member 50 is supported by the holding plate 40 and disposed separated from the flexible plate-shaped portion 31 of the diaphragm 30 or is formed to surround the heat insulating member 60, and thus it is possible to efficiently suppress heat transfer from the diaphragm 30 and a wall portion of the housing to the piezoelectric element 72.

As illustrated in FIGS. 3 to 5, the heat insulating member 60 is formed to have a columnar shape having a predetermined height and an outer diameter equal to the outer diameters of the protrusion portion 32 and the first electrode 71 by using an insulating material having an electrical insulating property and a thermal insulating property.

Here, an insulating material for forming the heat insulating member 60 may have a high heat capacity and a low thermal conductivity. The thermal conductivity is, for example, preferably equal to or less than 15 W/m·K, and more preferably equal to or less than 5 W/m·K. Examples of a specific material include ceramics such as quartz glass, steatite, zirconia, cordierite, forsterite, mullite, and yttria or a conductive material subjected to insulation treatment.

In addition, the heat insulating member 60 is closely disposed between the holding plate 40 abutting against the protrusion portion 32 of the diaphragm 30 and the first electrode 71 inside the sub-housing 20.

That is, the heat insulating member 60 is disposed so as to be interposed between the diaphragm 30 and the first electrode 71.

Thereby, the heat insulating member 60 functions so as to suppress heat transfer from the diaphragm 30 to the first electrode 71.

That is, a load due to pressure received by the diaphragm 30 is transmitted to the piezoelectric element 72 through the holding plate 40, the heat insulating member 60, and the first electrode 71, and heat transfer from the diaphragm 30 to the first electrode 71 is suppressed by the heat insulating member 60.

Accordingly, the influence of heat on the piezoelectric element 72 adjacent to the first electrode 71 is suppressed, so that it is possible to prevent a fluctuation in a reference point (zero point) of a sensor output and to obtain predetermined sensor accuracy.

The pressure measurement member 70 functions in order to detect a pressure and includes the first electrode 71, the piezoelectric element 72, and the second electrode 73 which are sequentially stacked from the tip end side thereof in the direction of the axial line S inside the sub-housing 20 as illustrated in FIGS. 3 to 5.

The first electrode 71 is formed to have a columnar or disk shape having an outer diameter fitted into the through hole 51 of the positioning member 50 by using a conductive metal material such as precipitation hardening or ferritic stainless steel.

In addition, the first electrode 71 is disposed such that one surface thereof is in close contact with the heat insulating member 60 and the other surface is in close contact with the piezoelectric element 72 inside the through hole 51 of the positioning member 50.

The piezoelectric element 72 is formed in a quadrangular prism shape having dimensions so as not to be in contact with the through hole 51 of the positioning member 50.

In addition, the piezoelectric element 72 is disposed such that one surface thereof is in close contact with the first electrode 71 and the other surface is in close contact with the second electrode 73 inside the through hole 51 of the positioning member 50.

Thereby, the piezoelectric element 72 outputs an electrical signal on the basis of distortion due to a load received in the direction of the axial line S.

In addition, as the piezoelectric element 72, ceramics such as zinc oxide (ZnO), barium titanate (BaTiO3), and lead zirconate titanate (PZT), quartz crystal, and the like are applied.

The second electrode 73 is formed to have a columnar or cylindrical shape having an outer diameter fitted into the through hole 51 of the positioning member 50 by using a conductive metal material such as precipitation hardening or ferritic stainless steel.

In addition, the second electrode 73 is disposed such that one surface thereof is in close contact with the piezoelectric element 72 and the other surface is in close contact with the insulating member 82 inside the through hole 51 of the positioning member 50.

As illustrated in FIGS. 3 to 5, the preload imparting member 80, which is disposed inside the sub-housing 20 constituting a portion of the housing, plays a role of pressing the pressure measurement member 70 toward the diaphragm 30 to impart a preload and imparting linear characteristics as a sensor to the pressure measurement member 70, and is constituted by the fixation member 81 and the insulating member 82.

The fixation member 81 is formed to have a substantially solid columnar shape having no hollow or punch in a center region centering on the axial line S and occupying an area equal to or greater than that of the through hole 51 by using a metal material such as precipitation hardening or ferritic stainless steel.

In addition, the fixation member 81 includes two vertical grooves 81a in an outer peripheral region deviated from the center region.

The two vertical grooves 81a are formed to be punched at positions point-symmetrical to and separated from each other by 180 degrees around the axial line S in order to respectively allow the lead wires 91 and 92 to pass therethrough.

The insulating member 82 is formed to have a columnar or disk shape having an outer diameter fitted into the through hole 51 of the positioning member 50 by using an insulating material having excellent electrical insulating properties.

That is, the insulating member 82 is formed to have a solid form having no hollow or punch in the entire region occupying an area equal to that of the through hole 51.

In addition, the insulating member 82 functions to maintain electrical insulation between the second electrode 73 and the fixation member 81 and guide heat transferred to the piezoelectric element 72 to the fixation member 81 to discharge heat.

Further, in this embodiment, the heat insulating member 60, the first electrode 71, the second electrode 73, and the insulating member 82 are formed to have substantially the same outer diameter and substantially the same thickness dimension, that is, to have substantially the same shape.

The insulating material of the insulating member 82 may have a low heat capacity and a high thermal conductivity, and examples of a specific material include ceramics such as alumina, sapphire, aluminum nitride, and silicon carbide or a conductive material subjected to insulation treatment.

Further, the insulating member 82 may have a thermal conductivity higher than a thermal conductivity of the heat insulating member 60, for example, equal to or higher than 30 W/m·K. In addition, the insulating member 82 may have a heat capacity lower than that of the heat insulating member 60. Accordingly, a heat transfer amount transferred to the piezoelectric element 72 can be suppressed by the heat insulating member 60 as much as possible, and heat transferred to the piezoelectric element 72 can be prompted to be discharged through the insulating member 82.

In the incorporating of the preload imparting member 80 having the above-described configuration, the insulating member 82 is fitted into the through hole 51 so as to abut against the second electrode 72 in a state where the pressure measurement member 70 is disposed inside the positioning member 50 as illustrated in FIGS. 4 and 5. In addition, the pressure measurement member 70 is pressed toward the diaphragm 30 in the direction of the axial line S so that the fixation member 81 abuts against the insulating member 82, and the fixation member 81 is fixed to the sub-housing 20 using welding or the like in a state where a preload is applied thereto.

In this manner, it is possible to impart linear characteristics as a sensor to the pressure measurement member 70 by imparting a preload with the preload imparting member 80. In addition, the insulating member 82 functions to maintain electrical insulation between the second electrode 72 and the fixation member 81 and guide heat transferred to the piezoelectric element 72 to the fixation member 81 to discharge heat. Therefore, the insulating member 82 may have a high thermal conductivity and a low heat capacity as described above.

As illustrated in FIGS. 2 and 4, the lead wire 91 is electrically connected to the first electrode 71 of the pressure measurement member 70, passes through one notched groove 54 of the positioning member 50, one vertical groove 81a of the fixation member 81, and the through passage 13 of the external housing 10, and is guided to the connector 100 in a state where the lead wire 91 is led while being insulated from the external housing 10.

That is, the first electrode 71 is connected to a terminal 102 of the connector 100 through the lead wire 91 and is electrically connected to a ground side (negative side) of an electrical circuit through an external connector.

As illustrated in FIGS. 2 and 4, the lead wire 92 is electrically connected to the second electrode 73 of the pressure measurement member 70, passes through the other notched groove 54 of the positioning member 50, the other vertical groove 81a of the fixation member 81, and the through passage 13 of the external housing 10, and is guided to the connector 100 in a state where the lead wire 92 is led while being insulated from the external housing 10.

That is, the second electrode 73 is connected to a terminal 103 of the connector 100 through the lead wire 92 and is electrically connected to an output side (positive side) of the electrical circuit through the external connector.

As illustrated in FIG. 2, the connector 100 includes a coupling portion 101 coupled to the connector connection portion 16 of the external housing 10, the terminal 102 which is fixed to the coupling portion 101 and electrically connected to the lead wire 91, and the terminal 103 which is fixed to the terminal 102 through an insulating member and electrically connected to the lead wire 92.

The terminals 102 and 103 are respectively connected to connection terminals of the external connector.

Next, an operation of incorporating the pressure sensor having the above-described configuration will be described.

When the operation is performed, the external housing 10, the sub-housing 20, the diaphragm 30, the holding plate 40, the positioning member 50, the heat insulating member 60, the first electrode 71, the piezoelectric element 72, the second electrode 73, the fixation member 81, the insulating member 82, the lead wire 91, the lead wire 92, and the connector 100 are prepared.

First, the diaphragm 30 is fixed to the tip end surface 23 of the sub-housing 20 using welding or the like.

Next, the holding plate 40 and the positioning member 50 are fitted into the sub-housing 20, and subsequently, the heat insulating member 60, the first electrode 71 to which the lead wire 91 is connected, the piezoelectric element 72, the second electrode 73 to which the lead wire 92 is connected, and the insulating member 82 are sequentially stacked and fitted into the positioning member 50.

In addition, the lead wires 91 and 92 may be respectively connected to the first electrode 71 and the second electrode 73 in a later process.

Thereafter, the fixation member 81 is fitted into the sub-housing 20 so as to press the insulating member 82, and the fixation member 81 is fixed to the sub-housing 20 using welding or the like in a state where a preload is applied thereto.

Thereby, as illustrated in FIGS. 4 and 5, a sensor module M1 is formed.

In addition, a method of incorporating the sensor module M1 is not limited to the above-described procedure, and the holding plate 40, the heat insulating member 60, the first electrode 71, the piezoelectric element 72, the second electrode 73, and the insulating member 82 may be incorporated into the positioning member 50 in advance, and the positioning member 50 having the above-described various components incorporated thereinto is fitted into the sub-housing 20, so that the fixation member 81 is fixed to the sub-housing 20 using welding or the like in a state where a preload is applied thereto.

Subsequently, the sensor module M1 is incorporated into the external housing 10. That is, the lead wires 91 and 92 pass through the through passage 13 of the external housing 10 and the sub-housing 20 is fitted into the fitting inner peripheral wall 11 of the external housing 10, so that the back-side end surface 24 abuts against the stepped portion 12.

Thereafter, the sub-housing 20 is fixed to the external housing 10 using welding.

Subsequently, the coupling portion 101 is fixed to the connector connection portion 16 of the external housing 10.

Subsequently, the lead wire 91 is connected to the terminal 102, and then the terminal 102 is fixed to the coupling portion 101.

Subsequently, the lead wire 92 is connected to the terminal 103, and then the terminal 103 is fixed to the terminal 102 through an insulating member.

Thereby, the connector 100 is fixed to the external housing 10.

Thus, the incorporating of the pressure sensor is completed.

In addition, the above-described incorporating procedure is merely an example and is not limited thereto, and other incorporating procedures may be adopted.

According to the pressure sensor of the above-described first embodiment, heat transferred to the diaphragm 30 is insulated by the heat insulating member 60, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, here, the heat insulating member 60 is formed of an insulating material, the first electrode 71 is directly connected to an electrical circuit through the lead wire 91, and the second electrode 73 is directly connected to the electrical circuit through the lead wire 92.

Therefore, it is possible to prevent the generation of a leak current which is a concern in a connection structure of the related art and to maintain predetermined sensor characteristics.

Specifically, in a case where the first electrode is connected to a ground of a cylinder head of an engine, or the like through a housing as in the related art, a decrease in an electrical resistance value of the piezoelectric element 72 results in a concern that a leak current passing through a feedback resistor of a circuit may be generated from a ground side, and a deviation (drift) of a measurement value may be generated, that is, a non-inverting amplifier circuit may be generated.

On the other hand, in the pressure sensor according to the first embodiment, since the first electrode 71 is directly connected to the electrical circuit through the lead wire 91, the above-described leak current is not generated, and thus predetermined sensor characteristics can be maintained.

Further, the housing includes the external housing 10 and the sub-housing 20 which is fitted into the external housing 10 and fixed thereto, and the diaphragm 30, the holding plate 40, the positioning member 50, the heat insulating member 60, the pressure measurement member 70, and the preload imparting member 80 are disposed in the sub-housing 20.

Accordingly, it is possible to form the sensor module M1 by previously incorporating the diaphragm 30, the holding plate 40, the positioning member 50, the heat insulating member 60, the pressure measurement member 70, and the preload imparting member 80 into the sub-housing 20.

Therefore, in a case where an attachment shape and the like vary depending on an application target, it is possible to share the sensor module M1 by setting only the external housing 10 for each application target.

FIGS. 6 and 7 illustrate a modification example in which thickness dimensions of the heat insulating member 60 and the insulating member 82 are changed and the depth of the notched groove 54 of the positioning member 50 is changed depending on the thickness of the heat insulating member 60 in the sensor module M1 according to the above-described first embodiment.

In the modification example, the heat insulating member 60 and the insulating member 82 are formed such that outer diameter dimensions are the same as those in the above-described first embodiment and thickness dimensions in the direction of the axial line S are different from those in the above-described first embodiment.

That is, a thickness dimension H1 of the heat insulating member 60 is formed to be larger than a thickness dimension H2 of the insulating member 82. In other words, the volume of the heat insulating member 60 is formed to be larger than the volume of the insulating member 82.

Here, the thickness dimension H1 of the heat insulating member 60 may be extremely large so that heat is not transferred in a range in which responsiveness of the pressure measurement member 70 can be secured.

On the other hand, the thickness dimension H2 of the insulating member 82 may be extremely small so as to prompt heat discharge as long as mechanical strength can be secured.

In this manner, it is possible to more improve thermal insulation with respect to the piezoelectric element 72 by making the heat insulating member 60 thicker than the insulating member 82 and to more improve a heat discharge property from the piezoelectric element 72 by making the insulating member 82 thinner than the heat insulating member 60 to prompt heat movement from the piezoelectric element 72 to the fixation member 81 through the insulating member 82.

FIGS. 8 to 10 illustrate a pressure sensor according to a second embodiment of the disclosure in which the positioning member, the holding plate, and the heat insulating member in the sensor module M1 according to the above-described first embodiment are changed. Therefore, the same components as those of the pressure sensor according to the above-described first embodiment are denoted by the same reference numeral and signs, and description thereof will be omitted.

The pressure sensor according to the second embodiment includes an external housing 10 and a sub-housing 20, a diaphragm 30, a positioning member 150, a pressure measurement member 70, a preload imparting member 80, a lead wire 91, a lead wire 92, and a connector 100.

The positioning member 150 is formed to have a substantially bottomed cylindrical shape extending in the direction of the axial line S by using an insulating material having an electrical insulating property and a thermal insulating property, and includes a cylindrical concave portion 151 centering on an axial line S, a flat plate portion 152 interposed between a protrusion portion 32 and a first electrode 71, an outer peripheral surface 53, and two notched grooves 54.

In addition, an insulating material for forming the positioning member 150 is the same as the above-described heat insulating member 60 and positioning member 50.

In addition, the positioning member 150, which is fitted to an inner peripheral wall 22 of the sub-housing 20 and is configured such that the flat plate portion 152 abuts against the protrusion portion 32, positions and holds the pressure measurement member 70 constituted by the first electrode 71, a piezoelectric element 72, and a second electrode 73, and the insulating member 82 in a stacked state inside a concave portion 151.

That is, the positioning member 150 is disposed inside the sub-housing 20 constituting a portion of the housing. The pressure measurement member 70 and the insulating member 82 are fitted into the concave portion 151 so as to be positioned on the axial line S of the housing.

Therefore, it is possible to position the first electrode 71, the piezoelectric element 72, and the second electrode 73 constituting the pressure measurement member 70 on the axial line S with the positioning member 150 as a reference while securing insulating properties of both the electrodes to easily incorporate these components.

Here, the flat plate portion 152 is interposed between the diaphragm 30 and the first electrode 71 to play a role as a heat insulating member for suppressing heat transfer from the diaphragm 30 to the first electrode 71.

That is, the positioning member 150 positions the pressure measurement member 70 on the axial line S to hole the pressure measurement member and also serves as a heat insulating member which is interposed between the diaphragm 30 and the first electrode 71.

In this manner, since the positioning member 150 is formed to serve as a heat insulating member, a holding plate 40 and a heat insulating member 60 in the first embodiment are not required, and it is possible to reduce the number of components as compared to a case where a heat insulating member is provided separately.

In addition, since the flat plate portion 152 is formed integrally as a portion of the positioning member 150, the entire positioning member 150 functions as a heat insulating member having a high heat capacity.

According to the pressure sensor of the above-described second embodiment, heat transferred to the diaphragm 30 is insulated by the positioning member 150, and thus heat transfer from the first electrode 71 to the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In particular, the positioning member 150 serves as a heat insulating member, and thus it is possible to reduce the number of components and simplify a structure.

In addition, since the positioning member 150 is formed of an insulating material, the first electrode 71 is directly connected to an electrical circuit through a lead wire 91, and the second electrode 73 is directly connected to the electrical circuit through a lead wire 92, a leak current is not generated and predetermined sensor characteristics can be maintained similar to the first embodiment.

Further, the housing includes the external housing 10 and the sub-housing 20 which is fitted into the external housing 10 and fixed thereto, and the diaphragm 30, the positioning member 150, the pressure measurement member 70, and the preload imparting member 80 are disposed in the sub-housing 20.

That is, it is possible to form a sensor module M2 by previously incorporating the diaphragm 30, the positioning member 150 serving as a heat insulating member, the pressure measurement member 70, and the preload imparting member 80 into the sub-housing 20.

Therefore, in a case where an attachment shape and the like vary depending on an application target, it is possible to share the sensor module M2 by setting only the external housing 10 for each application target.

FIGS. 11 to 14 illustrate a pressure sensor according to a third embodiment of the disclosure. The same components as those of the pressure sensor according to the above-described first embodiment are denoted by the same reference numeral and signs, and description thereof will be omitted.

The pressure sensor according to the third embodiment includes an external housing 110 and a sub-housing 20 as tubular housings defining an axial line S, a diaphragm 30, a positioning member 250, a heat insulating member 160, a pressure measurement member 170, a preload imparting member 180, a lead wire 190 as a conductor, and a connector 200.

The pressure measurement member 170 is constituted by a first electrode 71, a piezoelectric element 72, and a second electrode 173 which are sequentially stacked in the direction of the axial line S from a tip end side of the housing.

The preload imparting member 180 is constituted by a fixation member 181 and an insulating member 182.

An external housing 110 is formed to have a cylindrical shape extending in the direction of the axial line S by using a metal material such as precipitation hardening or ferritic stainless steel, and includes a fitting inner peripheral wall 11, a stepped portion 12, a through passage 13, a male screw portion 14, a flange portion 15, and a connector connection portion 116.

The connector connection portion 116 is formed to be connected to the connector 200.

The heat insulating member 160 has electrical conductivity and thermal insulation and is formed to have a columnar shape having a predetermined height and an outer diameter equal to the outer diameters of a protrusion portion 32 and the first electrode 71.

Here, the heat insulating member 160 may have a high heat capacity and a low thermal conductivity. The thermal conductivity is, for example, preferably equal to or less than 15 W/m·K, and more preferably equal to or less than 5 W/m·K. Examples of a specific material include a conductive coat insulating material obtained by providing a conductive thin film on the surface of a member, such as a ceramic, formed of a low heat conductive material, a thermal insulation conductive material having a layered structure in which silicon layer and germanium layers are alternately arranged, other thermal insulation conductive materials, and the like.

In addition, the heat insulating member 160 is closely disposed between the protrusion portion 32 of the diaphragm 30 and the first electrode 71 inside the sub-housing 20.

That is, the heat insulating member 160 is disposed so as to be interposed between the diaphragm 30 and the first electrode 71.

Thereby, the heat insulating member 160 functions to electrically connect the first electrode 71 to the housings (the external housing 110 and the sub-housing 20) through the diaphragm 30 and to suppress heat transfer from the diaphragm 30 to the first electrode 71.

The pressure measurement member 170 functions in order to detect a pressure and includes the first electrode 71, the piezoelectric element 72, and the second electrode 173 which are sequentially stacked from the tip end side thereof in the direction of the axial line S inside the sub-housing 20.

The first electrode 71 is disposed such that one surface thereof is in close contact with the heat insulating member 160 and the other surface is in close contact with the piezoelectric element 72 inside a through hole 51 of the positioning member 250.

That is, the first electrode 71 is electrically connected to a ground side (negative side) of an electrical circuit through the heat insulating member 160, the diaphragm 30, and the housings (the external housing 110 and the sub-housing 20).

The second electrode 173 is formed to have a columnar or cylindrical shape having an outer diameter fitted into the through hole 51 of the positioning member 250 by using a conductive metal material such as precipitation hardening or ferritic stainless steel, and includes a cylindrical connection portion 173a to be connected to a lead wire 190 on one end surface thereof.

In addition, the second electrode 173 is disposed such that one surface thereof is in close contact with the piezoelectric element 72 and the other surface is in close contact with the insulating member 182 inside the through hole 51 of the positioning member 50, is connected to a terminal 202 of the connector 200 through the lead wire 190, and is electrically connected to an output side (positive side) of the electrical circuit through the external connector.

The preload imparting member 180, which is disposed inside the sub-housing 20 constituting a portion of the housing, plays a role of pressing the pressure measurement member 170 toward the diaphragm 30 to impart a preload and imparting linear characteristics as a sensor to the pressure measurement member 170, and is constituted by the fixation member 181 and the insulating member 182.

The fixation member 181 is formed to have a substantially columnar shape by using a metal material such as precipitation hardening or ferritic stainless steel, and includes a through hole 181a that allows the lead wire 190 to pass through in a center region centering on the axial line S.

The insulating member 182 is formed to have a columnar or cylindrical shape having an outer diameter fitted into the through hole 51 of the positioning member 250 by using an insulating material having excellent electrical insulating properties, and includes a through hole 182a that allows the connection portion 173a of the second electrode 173 and the lead wire 190 to pass through in the center region centering on the axial line S.

Here, the insulating material of the insulating member 182 may have a low heat capacity and a high thermal conductivity, and examples of a specific material include ceramics such as alumina, sapphire, aluminum nitride, and silicon carbide or a conductive material subjected to insulation treatment.

Further, the insulating member 182 may have a thermal conductivity higher than a thermal conductivity of the heat insulating member 160, for example, equal to or higher than 30 W/m·K. In addition, the insulating member 182 may have a heat capacity lower than that of the heat insulating member 160. Accordingly, a heat transfer amount transferred to the piezoelectric element 72 can be reduced by the heat insulating member 160 as much as possible, and heat transferred to the piezoelectric element 72 can be caused to be discharged through the insulating member 182.

The lead wire 190 is electrically connected to the second electrode 173 of the pressure measurement member 170, passes through the through hole 182a of the insulating member 182, the through hole 181a of the fixation member 181, and the through passage 13 of the external housing 110, and is guided to the connector 200 in a state where the lead wire 190 is led while being insulated from the external housing 110.

That is, the second electrode 173 is connected to the terminal 202 of the connector 200 through the lead wire 190 and is electrically connected to an output side (positive side) of the electrical circuit through the external connector.

The connector 200 includes a coupling portion 201 coupled to the connector connection portion 116 of the external housing 110, and the terminal 202 which is fixed to the coupling portion 201 through an insulating member and electrically connected to the lead wire 190. The terminal 202 is connected to a connection terminal of the external connector.

The positioning member 250 is formed to have a substantially cylindrical shape extending in the direction of the axial line S by using an insulating material having an electrical insulating property and a thermal insulating property, and includes a cylindrical through hole 51 centering on the axial line S, an outer peripheral surface 53, and an end surface 252 which is in contact with a flexible plate-shaped portion 31 of the diaphragm 30.

In addition, an insulating material for forming the positioning member 250 is the same as the above-described positioning members 50 and 150.

In addition, the positioning member 250, which is fitted to an inner peripheral wall 22 of the sub-housing 20, positions and holds the protrusion portion 32 of the diaphragm 30, the heat insulating member 160, the pressure measurement member 170 constituted by the first electrode 71, the piezoelectric element 72, and the second electrode 173, and the insulating member 182 in a stacked state inside the through hole 51.

That is, the positioning member 250 is disposed inside the sub-housing 20 constituting a portion of the housing. The protrusion portion 32, the heat insulating member 160, the pressure measurement member 170, and the insulating member 182 are fitted into the through hole 51 so as to be positioned on the axial line S of the housing.

Therefore, it is possible to position the protrusion portion 32, and the first electrode 71, the piezoelectric element 72, and the second electrode 173 that constitute the pressure measurement member 170 on the axial line S with the positioning member 250 as a reference while securing insulating properties of both the electrodes to easily incorporate these components.

In addition, the thermal conductivity of the positioning member 250 may be equal to the thermal conductivity of the heat insulating member 160 and lower than the thermal conductivity of the insulating member 182. Thereby, it is also possible to make the positioning member 250 function as a heat insulating member.

Further, since the positioning member 250 is formed to surround the heat insulating member 160 and the pressure measurement member 170, it is possible to efficiently suppress heat transfer from the diaphragm 30 and a wall portion of the housing to the piezoelectric element 72.

According to the pressure sensor of the above-described third embodiment, heat transferred to the diaphragm 30 is insulated by the heat insulating member 160, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, the housing includes the external housing 110 and the sub-housing 20 which is fitted into the external housing 110 and fixed thereto, and the diaphragm 30, the positioning member 250, the heat insulating member 160, the pressure measurement member 170, and the preload imparting member 180 are disposed in the sub-housing 20.

That is, it is possible to form a sensor module M3 by previously incorporating the diaphragm 30, the positioning member 250, the heat insulating member 160, the pressure measurement member 170, and the preload imparting member 180 into the sub-housing 20.

Therefore, in a case where an attachment shape and the like vary depending on an application target, it is possible to share the sensor module M3 by setting only the external housing 110 for each application target.

FIGS. 15 and 16 illustrate a pressure sensor according to a fourth embodiment of the disclosure, and the fourth embodiment is the same as the above-described third embodiment except that an electrical connection passage of the first electrode 71 and a heat insulating member in the sensor module M3 according to the third embodiment are changed. Therefore, the same components as those of the pressure sensor according to the above-described third embodiment are denoted by the same reference numerals and signs, and description thereof will be omitted.

The pressure sensor according to the fourth embodiment includes an external housing 110 and a sub-housing 20 as tubular housings defining an axial line S, a diaphragm 30, a positioning member 250, a heat insulating member 260, a pressure measurement member 170, a preload imparting member 180, a compression spring 191 as a first conductor, a lead wire 192 as a second conductor, and a connector 200.

The compression spring 191 electrically connects the first electrode 71 and the diaphragm 30 to each other and is formed to have a coil shape using a conductive spring material.

In addition, the compression spring 191 is compressively disposed in contact with a protrusion portion 32 of the diaphragm 30 and the first electrode 71 inside a through hole 261 of the heat insulating member 260.

That is, the first electrode 71 is electrically connected to a ground side (negative side) of an electrical circuit through the compression spring 191, the diaphragm 30, and the housings (the external housing 110 and the sub-housing 20).

Similarly to the above-described lead wire 190, the lead wire 192 is electrically connected to a second electrode 173, passes through through holes 182a and 181a and a through passage 13, and is guided to the connector 200 in a state where the lead wire 192 is led while being insulated from the external housing 110.

That is, the second electrode 173 is connected to a terminal 202 of the connector 200 through the lead wire 192 and is electrically connected to an output side (positive side) of the electrical circuit through an external connector.

As illustrated in FIGS. 15 and 16, the heat insulating member 260 includes a circular through hole 261 which is formed to have a columnar shape having a predetermined height and an outer diameter equal to the outer diameters of the protrusion portion 32 and the first electrode 71 and centers on the axial line S by using an insulating material having an electrical insulating property and a thermal insulating property.

The through hole 261 is formed such that the compression spring 191 is accepted so as to be expandable and contractible.

In addition, an insulating material for forming the heat insulating member 260 is the same as that of the heat insulating member 60.

In addition, the heat insulating member 260 is closely disposed between in the protrusion portion 32 of the diaphragm 30 and the first electrode 71 inside the sub-housing 20.

That is, the heat insulating member 260 is disposed so as to be interposed between the diaphragm 30 and the first electrode 71.

Thereby, the heat insulating member 260 functions to suppress heat transfer from the diaphragm 30 to the first electrode 71.

According to the pressure sensor of the above-described fourth embodiment, heat transferred to the diaphragm 30 is insulated by the heat insulating member 260, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, the compression spring 191 disposed in the through hole 261 of the heat insulating member 260 is adopted as a first conductor connected to the first electrode 71 and the diaphragm 30, so that it is possible to increase the proportion of high thermal insulating air occupied inside the through hole 261 and more improve thermal insulation. Further, it is possible to maintain an electrical contact point using a biasing force of a spring by adopting the compression spring 191.

In addition, the housing includes the external housing 110 and the sub-housing 20 which is fitted into the external housing 110 and fixed thereto, and the diaphragm 30, the positioning member 250, the heat insulating member 260, the compression spring 191, the pressure measurement member 170, and the preload imparting member 180 are disposed in the sub-housing 20.

That is, it is possible to form a sensor module M4 by previously incorporating the diaphragm 30, the positioning member 250, the heat insulating member 260, the compression spring 191, the pressure measurement member 170, and the preload imparting member 180 into the sub-housing 20.

Therefore, in a case where an attachment shape and the like vary depending on an application target, it is possible to share the sensor module M4 by setting only the external housing 110 for each application target.

FIGS. 17 and 18 illustrate a pressure sensor according to a fifth embodiment of the disclosure, and the fifth embodiment is the same as the above-described third embodiment except that an electrical connection passage of the first electrode 71, a heat insulating member, and a positioning member in the sensor module M3 according to the third embodiment are changed. Therefore, the same components as those of the pressure sensor according to the above-described third embodiment are denoted by the same reference numerals and signs, and description thereof will be omitted.

The pressure sensor according to the fifth embodiment includes an external housing 110 and a sub-housing 20 as tubular housings defining an axial line S, a diaphragm 30, a positioning member 350, a heat insulating member 360, a pressure measurement member 170, a preload imparting member 180, a lead wire 291 as a first conductor, a lead wire 192 as a second conductor, and a connector 200.

The lead wire 291 electrically connects the first electrode 71 and the diaphragm 30 to each other and is formed to be bent across the heat insulating member 360.

In addition, the lead wire 291 is disposed around the heat insulating member 360 and inside a notched groove 354 of the positioning member 350, and is connected to a protrusion portion 32 of the diaphragm 30 and the first electrode 71.

That is, the first electrode 71 is electrically connected to a ground side (negative side) of an electrical circuit through the lead wire 291, the diaphragm 30, and the housings (the external housing 110 and the sub-housing 20).

The positioning member 350 is formed to have a substantially cylindrical shape extending in the direction of the axial line S by using an insulating material having an electrical insulating property and a thermal insulating property, and includes a through hole 51 centering on the axial line, an outer peripheral surface 53, an end surface 252, and the notched groove 354.

In addition, an insulating material for forming the positioning member 350 is the same as the above-described positioning members 50, 150, and 250.

In addition, the positioning member 350 is fitted to an inner peripheral wall 22 of the sub-housing 20, and positions and holds the protrusion portion 32 of the diaphragm 30, the heat insulating member 360, the pressure measurement member 170 constituted by the first electrode 71, a piezoelectric element 72, and a second electrode 173, and an insulating member 182 in a stacked state inside the through hole 51.

That is, the positioning member 350 is disposed inside the sub-housing 20 constituting a portion of the housing. The protrusion portion 32, the heat insulating member 360, the pressure measurement member 170, and the insulating member 182 are fitted into the through hole 51 so as to be positioned on the axial line S of the housing.

Therefore, it is possible to position the protrusion portion 32, and the first electrode 71, the piezoelectric element 72 and the second electrode 173 that constitute the pressure measurement member 170 on the axial line S with the positioning member 350 as a reference while securing insulating properties of both the electrodes to easily incorporate these components.

Further, a thermal conductivity of the positioning member 350 may be equal to a thermal conductivity of the heat insulating member 360 and lower than a thermal conductivity of the insulating member 182. Thereby, it is also possible to make the positioning member 350 function as a heat insulating member.

Further, the positioning member 350 is formed to surround the heat insulating member 360 and the pressure measurement member 170, and thus it is possible to efficiently suppress heat transfer from the diaphragm 30 and a wall portion of the housing to the piezoelectric element 72.

The heat insulating member 360 is formed to have a columnar shape having a predetermined height and an outer diameter equal to the outer diameters of the protrusion portion 32 and the first electrode 71 by using an insulating material having an electrical insulating property and a thermal insulating property.

In addition, an insulating material for forming the heat insulating member 360 is the same as those of heat insulating members 60 and 260.

In addition, the heat insulating member 360 is closely disposed between the protrusion portion 32 of the diaphragm 30 and the first electrode 71 inside the sub-housing 20.

That is, the heat insulating member 360 is disposed so as to be interposed between the diaphragm 30 and the first electrode 71.

Thereby, the heat insulating member 360 functions to suppress heat transfer from the diaphragm 30 to the first electrode 71.

According to the pressure sensor of the above-described fifth embodiment, heat transferred to the diaphragm 30 is insulated by the heat insulating member 360, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, the housing includes the external housing 110 and the sub-housing 20 which is fitted into the external housing 110 and fixed thereto, and the diaphragm 30, the positioning member 350, the heat insulating member 360, the lead wire 291, the pressure measurement member 170, and the preload imparting member 180 are disposed in the sub-housing 20.

That is, it is possible to form a sensor module M5 by previously incorporating the diaphragm 30, the positioning member 350, the heat insulating member 360, the lead wire 291, the pressure measurement member 170, and the preload imparting member 180 into the sub-housing 20.

Therefore, in a case where an attachment shape and the like vary depending on an application target, it is possible to share the sensor module M5 by setting only the external housing 110 for each application target.

FIGS. 19 and 20 illustrate a pressure sensor according to a sixth embodiment of the disclosure, and the sixth embodiment is the same as the above-described third embodiment except that an electrical connection passage of the first electrode 71, a heat insulating member, and a preload imparting member in the sensor module M3 according to the third embodiment are changed and a positioning member is deleted. Therefore, the same components as those of the pressure sensor according to the above-described third embodiment are denoted by the same reference numerals and signs, and description thereof will be omitted.

The pressure sensor according to the sixth embodiment includes an external housing 110 and a sub-housing 20 as tubular housings defining an axial line S, a diaphragm 30, a heat insulating member 460, a pressure measurement member 170, a preload imparting member 280, a lead wire 391 as a first conductor, a lead wire 192 as a second conductor, and a connector 200.

The preload imparting member 280 is constituted by a fixation member 281 and an insulating member 182.

The fixation member 281 is formed to have a substantially columnar shape by using a metal material such as precipitation hardening or ferritic stainless steel, and includes a through hole 281a that allows the lead wire 192 to pass through in a center region centering on the axial line S, a fitting portion 281b having a columnar shape centering on the axial line S, and a cylindrical sleeve 281c fitted to the fitting portion 281b.

The sleeve 281c plays a role of positioning the pressure measurement member 170 constituted by the first electrode 71, the piezoelectric element 72, and the second electrode 173 and the insulating member 182 on the axial line S in a state where the sleeve is fitted to the fitting portion 281b.

In addition, the sleeve 281c may be formed integrally with the fitting portion 281b. That is, the sleeve 281c plays a role as a positioning member in the above-described embodiment.

The lead wire 391 is electrically connected to the first electrode 71 and the sleeve 281c of the fixation member 281.

Here, the lead wire 391 is formed of a wiring material having flexibility such as a bonding wire so that the first electrode 71 pressing the piezoelectric element 72 in accordance with a pressure received by the diaphragm 30 is movable.

That is, the first electrode 71 is electrically connected to a ground side (negative side) of an electrical circuit through the lead wire 391, the fixation member 281, and the housings (the external housing 110 and the sub-housing 20).

As illustrated in FIG. 20, the heat insulating member 460 is formed to have a substantially columnar shape by using an insulating material having an electrical insulating property and a thermal insulating property and includes a fitting hole 461 which is fitted to the protrusion portion 32.

In addition, an insulating material for forming the heat insulating member 460 is the same as those of the heat insulating members 60, 260, and 360.

In addition, the heat insulating member 460 is closely disposed between the protrusion portion 32 and the first electrode 71 by fitting the protrusion portion 32 of the diaphragm 30 to the fitting hole 461 inside the sub-housing 20.

That is, the heat insulating member 460 is disposed so as to be interposed between the diaphragm 30 and the first electrode 71.

Thereby, the heat insulating member 460 functions to suppress and prevent heat transfer from the diaphragm 30 to the first electrode 71.

According to the pressure sensor of the above-described sixth embodiment, heat transferred to the diaphragm 30 is insulated by the heat insulating member 460, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, the housing includes the external housing 110 and the sub-housing 20 which is fitted into the external housing 110 and fixed thereto, and the diaphragm 30, the heat insulating member 460, the lead wire 391, the pressure measurement member 170, and the preload imparting member 280 are disposed in the sub-housing 20.

That is, it is possible to form a sensor module M6 by previously incorporating the diaphragm 30, the heat insulating member 460, the lead wire 391, the pressure measurement member 170, and the preload imparting member 280 into the sub-housing 20.

Therefore, in a case where an attachment shape and the like vary depending on an application target, it is possible to share the sensor module M6 by setting only the external housing 110 for each application target.

FIG. 21 illustrates a pressure sensor according to a seventh embodiment of the disclosure, and the seventh embodiment is the same as the above-described third embodiment except that an electrical connection passage of the first electrode 71, a heat insulating member, and a positioning member in the sensor module M3 according to the third embodiment are changed. Therefore, the same components as those of the pressure sensor according to the above-described third embodiment are denoted by the same reference numerals and signs, and description thereof will be omitted.

The pressure sensor according to the seventh embodiment includes an external housing 110 and a sub-housing 20 as tubular housings defining an axial line S, a diaphragm 30, a positioning member 450, a heat insulating member 360, a pressure measurement member 170, a preload imparting member 380, a lead wire 491 as a first conductor, a lead wire 192 as a second conductor, and a connector 200.

The preload imparting member 380 is constituted by a fixation member 381 and an insulating member 182.

The fixation member 381 is formed to have a substantially columnar shape by using a metal material such as precipitation hardening or ferritic stainless steel, and includes a through hole 381a for allowing the lead wire 192 to pass through in a center region centering on the axial line S and a fitting hole 381b to which the lead wire 491 is fitted and electrically connected in a region close to the outside and deviated from the axial line S.

The positioning member 450 is formed to have a substantially cylindrical shape extending in the direction of the axial line S by using an insulating material having an electrical insulating property and a thermal insulating property, and includes a through hole 51 centering on the axial line S, an outer peripheral surface 53, an end surface 252, and a notched groove 454 that allows the lead wire 491 to pass through.

In addition, an insulating material for forming the positioning member 450 is the same as those of the above-described positioning members 50, 150, 250, and 350.

In addition, the positioning member 450 is fitted to an inner peripheral wall 22 of the sub-housing 20, and positions and holds the protrusion portion 32 of the diaphragm 30, the heat insulating member 360, the pressure measurement member 170 constituted by the first electrode 71, a piezoelectric element 72, and a second electrode 173, and an insulating member 182 in a stacked state inside the through hole 51.

That is, the positioning member 450 is disposed inside the sub-housing 20 constituting a portion of the housing. The protrusion portion 32, the heat insulating member 360, the pressure measurement member 170, and the insulating member 182 are fitted into the through hole 51 so as to be positioned on the axial line S of the housing.

Therefore, it is possible to position the protrusion portion 32, and the first electrode 71, the piezoelectric element 72 and the second electrode 173 that constitute the pressure measurement member 170 on the axial line S with the positioning member 450 as a reference while securing insulating properties of both the electrodes to easily incorporate these components.

Further, a thermal conductivity of the positioning member 450 may be equal to a thermal conductivity of the heat insulating member 360 and lower than a thermal conductivity of the insulating member 182. Thereby, it is also possible to make the positioning member 450 function as a heat insulating member.

Further, the positioning member 450 is formed to surround the heat insulating member 360 and the pressure measurement member 170, and thus it is possible to efficiently suppress heat transfer from the diaphragm 30 and a wall portion of the housing to the piezoelectric element 72.

The lead wire 491 is electrically connected to the first electrode 71 of the pressure measurement member 170, passes through the notched groove 454 of the positioning member 450, and is fitted and electrically connected to the fitting hole 381b of the fixation member 381.

Here, the lead wire 491 is formed of a wiring material having flexibility such as a bonding wire so that the first electrode 71 pressing the piezoelectric element 72 in accordance with a pressure received by the diaphragm 30 is movable.

That is, the first electrode 71 is electrically connected to a ground side (negative side) of an electrical circuit through the lead wire 491, the fixation member 381, and the housings (the external housing 110 and the sub-housing 20).

According to the pressure sensor of the above-described seventh embodiment, heat transferred to the diaphragm 30 is insulated by the heat insulating member 360, and thus heat transfer from the diaphragm 30 to the first electrode 71 and the piezoelectric element 72 is suppressed. Therefore, the influence of heat on the piezoelectric element 72 is suppressed, so that it is possible to prevent a fluctuation in a reference point (zero point) of a sensor output and to obtain predetermined sensor accuracy.

In addition, the housing includes the external housing 110 and the sub-housing 20 which is fitted into the external housing 110 and fixed thereto, and the diaphragm 30, the positioning member 450, the heat insulating member 360, the pressure measurement member 170, and the preload imparting member 380 are disposed in the sub-housing 20.

That is, it is possible to form a sensor module M7 by previously incorporating the diaphragm 30, the positioning member 450, the heat insulating member 360, the pressure measurement member 170, and the preload imparting member 380 into the sub-housing 20.

Therefore, in a case where an attachment shape and the like vary depending on an application target, it is possible to share the sensor module M7 by setting only the external housing 110 for each application target.

In the above-described embodiment, the diaphragm 30 integrally including the flexible plate-shaped portion 31 and the protrusion portion 32 has been described as a diaphragm. However, the disclosure is not limited thereto, and a configuration in which the flexible plate-shaped portion 31 and the protrusion portion 32 are formed separately so that the flexible plate-shaped portion 31 functions as a diaphragm and the protrusion portion 32 functions as a force transfer member may be adopted.

In the above-described embodiment, a configuration including the external housing 10 or 110 and the sub-housing 20 has been described as housings. However, the disclosure is not limited thereto, and one housing may be adopted.

As described above, the pressure sensors of the disclosure can secure predetermined sensor accuracy by suppressing the influence of heat. Therefore, the pressure sensors can be particularly applied as a pressure sensor that detects a pressure of a high temperature pressured medium such as a combustion gas inside a combustion chamber of an engine and is also useful as a pressure sensor that detects a pressure of a high temperature pressured medium other than a combustion gas or another pressured medium.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A pressure sensor comprising:
a conductive housing which is configured to have a tubular shape;
a conductive diaphragm which is fixed to a tip end of the housing and exposed to a pressured medium;
a pressure measurement member which includes a first electrode, a piezoelectric element, and a second electrode which are sequentially stacked inside the housing;
a preload imparting member which is disposed inside the housing in order to press the pressure measurement member toward the diaphragm to impart a preload; and
a heat-insulating member which is disposed inside the housing so as to be interposed between the diaphragm and the first electrode.

2. The pressure sensor according to claim 1, wherein
the diaphragm includes a flexible plate-shaped portion fixed to the housing and a protrusion portion protruding toward an inside of the housing from a center region of the flexible plate-shaped portion, and
the heat-insulating member is disposed so as to be interposed between the protrusion portion and the first electrode.

3. The pressure sensor according to claim 1, wherein the preload imparting member includes a conductive fixation member fixed to the housing and an insulating member disposed between the fixation member and the second electrode.

4. The pressure sensor according to claim 2, wherein the preload imparting member includes a conductive fixation member fixed to the housing and an insulating member disposed between the fixation member and the second electrode.

5. The pressure sensor according to claim 3, wherein a thermal conductivity of the insulating member is higher than a thermal conductivity of the heat-insulating member.

6. The pressure sensor according to claim 3, wherein a volume of the heat-insulating member is larger than a volume of the insulating member.

7. The pressure sensor according to claim 5, wherein a volume of the heat-insulating member is larger than a volume of the insulating member.

8. The pressure sensor according to claim 1, further comprising:
a positioning member formed of an insulating material and disposed inside the housing, and the pressure measurement member is fitted to the positioning member so as to be positioned on an axial line of the housing.

9. The pressure sensor according to claim 2, further comprising:
a positioning member formed of an insulating material and disposed inside the housing, and the pressure measurement member is fitted to the positioning member so as to be positioned on an axial line of the housing.

10. The pressure sensor according to claim 3, further comprising:
a positioning member formed of an insulating material and disposed inside the housing, and the pressure measurement member is fitted to the positioning member so as to be positioned on an axial line of the housing.

11. The pressure sensor according to claim 8, wherein
the preload imparting member includes a conductive fixation member fixed to the housing and an insulating member disposed between the fixation member and the second electrode, and
a thermal conductivity of the positioning member is lower than a thermal conductivity of the insulating member.

12. The pressure sensor according to claim 8, wherein
the diaphragm includes a flexible plate-shaped portion fixed to the housing and a protrusion portion protruding toward an inside of the housing from a center region of the flexible plate-shaped portion, and
the positioning member is disposed separated from the flexible plate-shaped portion.

13. The pressure sensor according to claim 8, wherein the positioning member is configured in a tubular shape so as to surround the heat-insulating member.

14. The pressure sensor according to claim 8, wherein the positioning member is configured to serve as the heat-insulating member.

15. The pressure sensor according to claim 1, wherein
the heat-insulating member is configured to have conductivity and thermal insulation, and
a conductor which is led while being insulated from the housing is connected to the second electrode.

16. The pressure sensor according to claim 1, wherein
the heat-insulating member is formed of an insulating material,
a first conductor connected to the diaphragm is connected to the first electrode, and
a second conductor which is led while being insulated from the housing is connected to the second electrode.

17. The pressure sensor according to claim 16, wherein the first conductor is a compression spring which is disposed between the diaphragm and the first electrode in a through hole provided in the heat-insulating member.

18. The pressure sensor according to claim 1, wherein
the preload imparting member includes a conductive fixation member fixed to the housing and an insulating member disposed between the fixation member and the second electrode,
the heat-insulating member if formed of an insulating material,
a first conductor connected to the fixation member is connected to the first electrode, and
a second conductor which is led while being insulated from the housing is connected to the second electrode.

19. The pressure sensor according to claim 1, wherein
the heat-insulating member is formed of an insulating material,
a first conductor which is led while being insulated from the housing is connected to the first electrode, and
a second conductor which is led while being insulated from the housing is connected to the second electrode.

20. The pressure sensor according to claim 1, further comprising:
a positioning member is formed of an insulating material and disposed inside the housing, and the pressure measurement member is fitted to the positioning member so as to be positioned on an axial line of the housing,
wherein the housing includes an external housing and a sub-housing which is fitted into and fixed to the external housing, and
the diaphragm, the positioning member, the heat-insulating member, the pressure measurement member, and the preload imparting member are disposed inside the sub-housing.
